(19) United States
(12) Patent Application Publication
(10) Pub. No.: US 2018/0282487 A1
(43) Pub. Date: Oct. 4, 2018

(54) PROCESS OF EXTRACTING AND PURIFYING HUMIC SUBSTANCES FROM SANITARY LANDFILL LEACHATE

(71) Applicant: Vladimir KUDRJAWZEW, Sao Paulo (BR)

(72) Inventor: Vladimir KUDRJAWZEW, Sao Paulo (BR)

(21) Appl. No.: 15/944,965

(22) Filed: Apr. 4, 2018

(30) Foreign Application Priority Data
Apr. 4, 2017 (BR) 1020170069087

(51) Int. Cl. C08H 7/00; C07G 1/00; C05B 17/00; C05F 11/02

(52) U.S. Cl. CPC C08H 6/00; C05F 11/02; C05B 17/00; C07G 1/00

(57) ABSTRACT

Process of extracting and purifying humic substances from sanitary landfill leachate comprises four steps: 1^{st} physical-chemical step with the withdrawal of inert solids class II-B, 2^{nd} step of filtration, 3^{rd} step of purification of the humic substances with ionic exchange column followed by reverse osmosis and 4^{th} step of catalytic oxidation and ammonolysis by cathodic reduction, obtaining treated effluents that complies with environmental legislation in terms of disposal or re-use of water.

This application claims priority benefit to Brazil Application No. 1020170069087, filed Apr. 4, 2017, which is hereby incorporated herein by reference in its entirety.

The present patent of invention for the process of extracting and purifying humic substances from sanitary landfill leachate withdraws the dirt present in the slurry to enable the extraction of the humic substances and the treated effluent (water) that complies with environmental legislation for disposal or re-use.

The humic substances are humins and fulvin monomers thereof, particularly humic acids and fulvic acids, product of the biological degradation of organic vegetable matter, act as soil conditioners retaining the humidity, facilitate plant absorption of nutrients, have major ionic exchange and metal chelation capacity and the fulvic acids are metabolized by the plant positively influencing the Krebs Cycle and facilitating photosynthesis.

The main form of obtaining humic substances is by way of turf which is a partially degraded vegetable substance formed mainly of sphagnum and hypnum, presented in the form of layers, the liquid turf has large amounts of carbon, which limits its application in agriculture; the demand for humic substances is enormous due to the benefits for farmable soil and for crops; the anaerobic degradation of any organic vegetable matter produces humic substances; the landfill leachate (slurry) is produced from the degradation of the solid urban residues and whose composition presents at least 40% in organic vegetable matter; the humic substances are found in the slurry of landfills in high concentrations and the existing processes for treating slurry do not enable the extraction of these substances.

Bearing in mind these difficulties and in order to overcome them, the process was developed to extract and purify humic substances from sanitary landfill leachate, divided into four consecutive steps, 1^{st} physical-chemical step of coagulation and flocculation of the suspended solids, whose withdrawn solid is an encapsulated metal chelate other than leachate, classified as CLASS II B; 2^{nd} filtration step, comprising sand filter, microfiltration and nanofiltration, whose the retained part is concentrated in humic substances; the 3^{rd} step of purification of the humic substances; and 4^{th} step of treatment of the permeated effluent to obtain water for re-use.

The drawings illustrate the equipment involved in the steps of the process of extracting and purifying humic substances from sanitary landfill leachate, the object of the present patent, the drawings being illustrations that contribute to an improved understanding of the present specification, wherein:

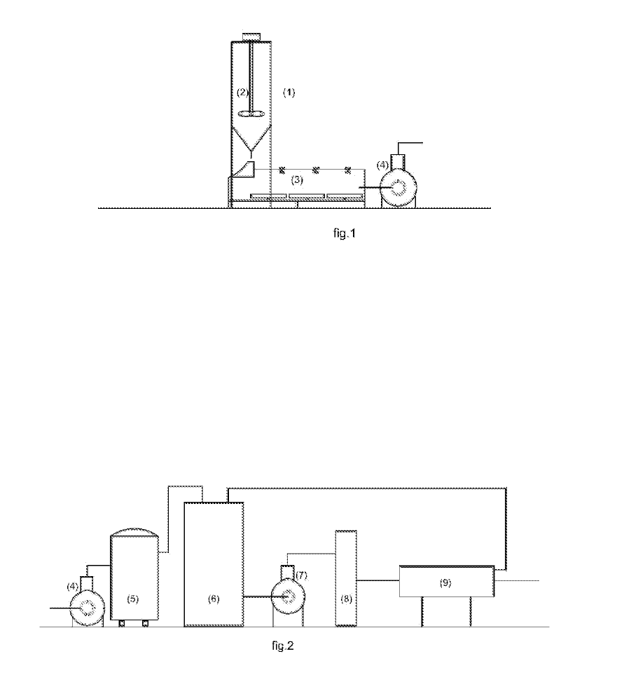

FIG. 1 illustrates the equipment involved in the 1^{st} physical-chemical step;

FIG. 2 illustrates the equipment involved in the 2^{nd} step of filtration;

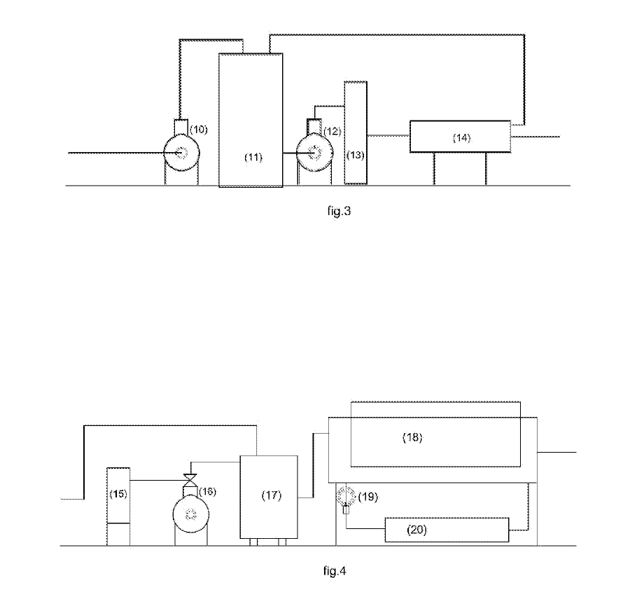

FIG. 3 illustrates the equipment involved in the 3^{rd} step of purifying the humic substances;

FIG. 4 illustrates the equipment involved in the 4^{th} step of treating the effluent for obtaining re-usable water;

The 1^{st} physical-chemical step takes place in a physical-chemical reactor (1), endowed with stirrer (2) and which uses the property of chelation of the humins present in the slurry; the slurry is pumped from the slurry pond to the physical-chemical reactor until it occupies 60% of the volume thereof, adding 0.35% to 0.70%, in volume of such reactor, of FeCl₃ (ferric chloride), to be defined by jar-test; Fe′ chelates the humins forming organo-metals which by allosteric effect causes the chelation of other metals present in the slurry and co-adsorption to amine groups forming the clot, FeCl₃ acidifies the medium which decomposes the carbonates (CO₃²⁻) present, with a large release of carbon gas (CO₂), which causes the formation of a foam that occupies from 20% to 30% of the volume of the physical-chemical reactor; the coagulation reaction takes place with stirring in the medium, 40 rpm on the stirrer shaft; after five (5) minutes the flocculation reaction begins by adding 600 ppm to 800 ppm of flocculant anionic polymer, with slow stirring, 20 rpm on the shaft of the stirrer, to prevent rupture of the flakes formed for 3 (three) minutes; the flocculant anionic polymer promotes the aggregation of the clots and uptake of oils and grease, suspended solids, etc.; the final size of the flake and the final encapsulation of the contaminant is obtained by adding 600 ppm to 1000 ppm of polyacrylamide cationic flocculant polymer, with slow stirring, 20 rpm on the shaft of the stirrer for three (3) minutes; the stirrer is switched off and the system rests for forty (40) minutes; due to the formation of carbon gas, the formed flakes float promoting the separation of the medium into two phases, supernatant solids and a gold-yellow colored liquid smelling of ammonium, mainly composed of humates and fulvates having different molecular weights, of ammonium, sodium, iron and chlorides; the physical-chemical reactor is unloaded onto a solid separation ramp, with a grid measuring 0.5 mm; the liquid phase contains the solids under 0.5 mm that fall into the flotation tank by dissolved air (3); the centrifugal pump (4) withdraws the liquid phase from the floater; a scraper withdraws the floated solids, the solid phase of the physical-chemical reactor forms a solid substrate which is taken to a dumpster for final disposal in the landfill itself; the dry solid is class II-B and not leach.

The 2^{nd} step is that of filtration and involves a quartz sand filter (5) for retaining coarse solids, a microfiltration (8) with polypropylene cartridges and retention of particles greater than 1 micrometer, for protecting the nanofiltration membrane (9); the post-physical-chemical (liquid phase) effluent is withdrawn from the floater by the pump (4) passing through the sand filter (5) and up to the retainate tank (6) of the nanofiltration; a multiple-stage pump (7) having pressure of 1470000 Pa pumps the effluent to pass through the microfiltration (8) and the nanofiltration membrane (9); the retentate from nanofiltration returns to the retainate tank (6) and the permeate follows on to the effluent treatment step; when the temperature of the permeate at the nanofiltration outlet reaches 40° C., the pressures being maintained, the nanofiltration process will be concluded.

The 3^{rd} step of purifying the humic substances; the concentrate from the nanofiltration is rich in organic nitrogen, especially the humic substances, humates and ammonium fulvate, in addition to calcium and sodium with traces of chloride; the nanoretainate is pumped (10) to the retainate tank (11) of reverse osmosis, and a high pressure pump pumps the solution by way of an ionic exchange resin column (13), withdrawing the traces of chloride and sodium from the concentrate; after the withdrawal of these ions, this solution of humic substances undergoes the process of reverse osmosis (14) so as to concentrate the humic substances in a volume 20% to 30% of the original volume in the retainate tank (11), and the water produced (permeated) by reverse osmosis is classified as water for re-use; the retainate of the reverse osmosis is a concentrate of humic substances which is raw material for soil conditioners or NPK fertilizer.

The 4^{th} step of treating effluent permeated in the nano filtration; begins by the catalytic oxidation of organic matter having lower molecular weight in the aeration tank with ozone (17); an ozone generator (15) injects ozone via the venturi circulation pump (16); the bottom of the tank features air diffusers and a radial compressor blows the air towards the diffusers; the oxidation consists of the in situ production of oxygen-reactive species (ORS) such as superoxide anion radical (O₂.⁻), hydrogen peroxide (H₂O₂), singlet dioxygen (O2), hydroxyl radical (HO.), and the effluent receives from 10 g to 20 g of ozone (O₃) per cubic meter (m³) of effluent to be oxidized, via venture pump (16), furnished by the ozone generator (15); the oxidized effluent having a concentration of Cl⁻ between 1000 mg/l and 2000 mg/l, of Fe³⁺ between 500 mg/l and 1500 mg/l, of Nh₄⁺ between 250 mg/l and 350 mg/l passes through the ammonolysis conduit by cationic reduction.

Ammonolysis by cathodic reduction involves a passage conduit (18), circulation pump (19), press filter (20); a set of electrodes having graphite cathode and stainless steel anode is mounted inside the conduit and the continuous current source maintains the electric potential difference between 4 volts and 6 volts in the electrodes; ammonolysis is a technique that consists of breaking the nitrogen-hydrogen bonds in the azo groups to increase the valence state of the nitrogen atom up to the formation of molecular nitrogen (N2), with release of H⁺, acidifying the medium; Fe²⁺ present in the medium acts to inhibit the reaction of nucleophilic addition of chloride in organic compounds, pursuant to the kinetic principles below:

Kinetic 1: (anode) Cl⁻+H₂O->ClO⁻+2H⁺+2e−;
Kinetic 2: (cathode) Fe²⁺+2e⁻->Fe⁰;
Kinetic 3: (decomposition of the ammonium): 3ClO⁻+2NH₄⁺->3Cl⁻+N₂+3H₂O+2H⁺; the cathodic ammonolysis reaction will be interrupted when the concentration of ammonium nitrogen reaches 3 mg/l; during ammonolysis the effluent is pumped to pass through a press filter, in which Fe⁰ hydrate is retained and recovered as ferric chloride by the addition of hydrochloric acid and to be re-used in the 1^{st} physical-chemical step; the effluent of the press filter returns to the ammonolysis conduit.

FIG. 1 illustrates the equipment involved in the 1^{st} physical-chemical step; physical-chemical reactor (1), stirrer (2), flotation tank by dissolved air and pump (4).

FIG. 2 illustrates the equipment involved in the 2^{nd} step of filtration; sand filter (5), retainate tank (humic substances) (6), high pressure pump (7), micro filtration (8), nano filtration (9).

FIG. 3 illustrates the equipment involved in the 3^{rd} step of purification of the humic substances; high pressure pump (10), ionic exchange column (13), reverse osmosis (14).

FIG. 4 illustrates the equipment involved in the 4^{th} step of effluent treatment; aeration tank (17), ozone generator (15), venturi pump (16), ammonolysis conduit (18), circulation pump (19) and press filter (20).

1. “PROCESS OF EXTRACTING AND PURIFYING HUMIC SUBSTANCES FROM SANITARY LANDFILL LEACHATE” comprising the following consecutive steps:
(i) physico-chemical treatment of a slurry, such slurry is inserted into a stirred reactor until 60% of its volume is filled and mixed with ferric chloride from 0.35% to 0.70% by volume of the reactor, said mixture is shaken at 40 rpm for five minutes to coagulate; to the resulting coagulated mixture is added an anionic flocculating polymer, the stirring being maintained at 20 rpm for three minutes, when a cationic flocculating polymer is added and the stirring is maintained at 20 rpm for another three minutes; the resulting mixture rests for forty minutes and is then transferred to a flotation tank by dissolved air;
(ii) filtration of a liquid fraction from the flotation tank in a sand filter, followed by a microfiltration and a nanofiltration resulting in a nanofiltration permeate and a retentate of the nanofiltration;
the process of extracting and purifying humic substances from sanitary landfill leachate is characterized by the fact that it further comprises the steps of:
(iii) purification of humic substances from the retentate of the nanofiltration, wherein said retentate is transferred to a retainate tank, pumped to an ionic exchange resin column, and then routed to a reverse osmosis to obtain water for re-use and concentrated humic substance; and
(iv) effluent treatment wherein the nanofiltration permeate is transferred to an aeration tank and ozone is injected to such tank resulting in an oxidized effluent which is transferred to an ammonolysis conduit where it is subjected to the electric potential difference until reaches the concentration of 3 mg/L of ammonium nitrogen obtaining an effluent, said effluent is then pumped to a press filter for retention of ionic residues, iron and nitrogen.

2. “PROCESS OF EXTRACTING AND PURIFYING HUMIC SUBSTANCES FROM SANITARY LANDFILL LEACHATE”, according to claim 1, characterized in that in the flocculation step of the physico-chemical step is added between 600 ppm and 800 ppm of flocculant anionic polymer.

3. “PROCESS OF EXTRACTING AND PURIFYING HUMIC SUBSTANCES FROM SANITARY LANDFILL LEACHATE”, according to claim 1, characterized in that in the flocculation step of the physico-chemical step is added between 600 ppm and 1000 ppm of polyacrylamide cationic flocculant polymer.

4. “PROCESS OF EXTRACTING AND PURIFYING HUMIC SUBSTANCES FROM SANITARY LANDFILL LEACHATE”, according to claim 1, characterized in that in the microfiltration step particles greater than 1 micrometer are retained.

5. “PROCESS OF EXTRACTING AND PURIFYING HUMIC SUBSTANCES FROM SANITARY LANDFILL LEACHATE”, according to claim 1, characterized in that the retentate from nanofiltration returns to the retainate tank.

6. “PROCESS OF EXTRACTING AND PURIFYING HUMIC SUBSTANCES FROM SANITARY LANDFILL LEACHATE”, according to claim 1, characterized in that the retainate of the reverse osmosis is a concentrate of humic substances which is raw material for soil conditioners or NPK fertilizer.

7. “PROCESS OF EXTRACTING AND PURIFYING HUMIC SUBSTANCES FROM SANITARY LANDFILL LEACHATE”, according to claim 1, characterized in that the aeration tank receives from 10 g to 20 g of ozone (O₃) per cubic meter (m³) of effluent to be oxidized.

8. “PROCESS OF EXTRACTING AND PURIFYING HUMIC SUBSTANCES FROM SANITARY LANDFILL LEACHATE”, according to claim 1, characterized in that the reverse osmosis concentrates the humic substances in a volume 20% to 30% of the original volume.

9. “PROCESS OF EXTRACTING AND PURIFYING HUMIC SUBSTANCES FROM SANITARY LANDFILL LEACHATE”, according to claim 1, characterized in that the passage conduit comprises electrodes having graphite cathode and stainless steel anode is mounted inside the conduit and the continuous current source maintains the electric potential difference between 4 volts and 6 volts in the electrodes.

10. “PROCESS OF EXTRACTING AND PURIFYING HUMIC SUBSTANCES FROM SANITARY LANDFILL LEACHATE”, according to claim 1, characterized in that the effluent of the press filter returns to the ammonolysis conduit.
